(19) United States
(12) Patent Application Publication
(10) Pub. No.: US 2014/0168294 A1
(43) Pub. Date: Jun. 19, 2014

(54) TRANSPORT APPARATUS AND RECORDING APPARATUS

(71) Applicant: SEIKO EPSON CORPORATION, Tokyo (JP)

(72) Inventors: Takahiro ABE, Shiojiri-shi (JP); Mitsutaka IDE, Shiojiri-shi (JP); Tomoya MUROTANI, Matsumoto-shi (JP)

(73) Assignee: SEIKO EPSON CORPORATION, Tokyo (JP)

(21) Appl. No.: 14/083,977

(22) Filed: Nov. 19, 2013

(30) Foreign Application Priority Data
Nov. 21, 2012 (JP) 2012-255010

(51) Int. Cl. B41J 11/00

(52) U.S. Cl. CPC B41J 11/00
USPC 347/2; 271/264; 347/104

(57) ABSTRACT

A transport apparatus includes: a transport unit that transports a transport target; an optical detection unit, including a light irradiation unit capable of irradiating the transport target with light and a light-receiving unit that receives light, that detects the transport target; and an output unit that compares a light receiving result from the light-receiving unit with a set value that has been set in advance and outputs a result of the comparison.

### BACKGROUND

1. Technical Field

The present invention relates to transport apparatuses that transport a transport target such as paper used in printing, and to recording apparatuses that include such transport apparatuses.

2. Related Art

Ink jet printers that carry out printing (a recording process) by ejecting ink from a recording head (a recording unit) onto recording paper (a transport target) are known as a type of a recording apparatus. Some such printers include an image capturing unit (a detection unit) having a light-emitting element (a light irradiation unit) and an image sensor (a light-receiving unit) provided with an optical system (for example, see JP-A-2007-217176).

In a printer such as that disclosed in JP-A-2007-217176, the surface state of the transported recording paper is captured as a continuous image by the image capturing unit; two sequential captured images are then compared in time series, a movement amount of a pattern of interest between the two images is calculated, and an actual transport amount of the recording paper is calculated by integrating the movement amounts.

In this case, images expressing non-planarities in the surface of the recording paper irradiated by the light-emitting element appear in the two images captured by the image capturing unit, and thus maintaining the contrast in the images of the surface of the recording paper captured by the image capturing unit ensures the accuracy of the calculation of the actual transport amount of the recording paper.

Incidentally, in the case where printing is executed with, for example, an outer cover (a cover member) open in a printer such as that disclosed in JP-A-2007-217176, the image capturing unit is negatively affected by ambient light (surrounding light), leading to a drop in the contrast of the image of the recording paper surface captured by the image capturing unit; this in turn makes it difficult to maintain the accuracy at which the image capturing unit captures the image of the recording paper surface. Accordingly, there is a problem that the recording apparatus is used in a state where the accuracy at which the image capturing unit captures the image of the recording paper surface is no longer maintained.

### SUMMARY

The invention has been conceived in light of such problems with past techniques. It is an advantage of some aspects of the invention to provide a transport apparatus and a recording apparatus capable of suppressing use in a state where the accuracy of a detection unit is no longer being maintained.

A summary of aspects of the invention for achieving the aforementioned advantage, and of effects of the invention, will be described below.

A transport apparatus according to an aspect of the invention includes: a transport unit that transports a transport target; an optical detection unit, having a light irradiation unit capable of irradiating the transport target with light and a light-receiving unit that receives light, that detects the transport target; and an output unit that compares a light receiving result from the light-receiving unit with a set value that has been set in advance and outputs a result of the comparison.

According to this configuration, information of the comparison between the set value and the light receiving result can be obtained if the set value is set to, for example, a value that can be detected even when the apparatus is affected by ambient light, and thus it can be determined whether or not the apparatus is in an appropriate state. Accordingly, the apparatus can be suppressed from being used in a state in which the accuracy of the detection unit is no longer maintained.

According to another aspect of the invention, in the stated transport apparatus, it is preferable for the light-receiving unit to be an image capturing unit that captures an image by receiving light, and for the light receiving result to be a brightness of an image captured by the image capturing unit.

According to this configuration, it can be determined whether or not the brightness of the image captured by the image capturing unit is appropriate, and thus the detection state can be suppressed from worsening; this in turn makes it possible to perform highly-precise transport control.

According to another aspect of the invention, in the stated transport apparatus, it is preferable for the output unit to output the result of the comparison in a state where the light irradiation unit is not emitting light.

According to this configuration, the influence of ambient light can be confirmed, which makes it possible to further suppress the detection state from worsening.

According to another aspect of the invention, it is preferable for the stated transport apparatus to further include a cover member that can be freely opened and closed, and for the detection unit to be disposed in a position where the detection unit is not affected by ambient light while the cover member is closed but is affected by the ambient light while the cover member is open.

According to this configuration, whether the cover member is open or closed can be determined based on the result of the comparison, and the apparatus can be suppressed from being used in a state where the accuracy is no longer maintained due to the detection unit being affected by ambient light as a result of the cover member being open.

A recording apparatus according to another aspect of the invention includes the transport apparatus configured as described above and a recording unit that performs a recording process on the transport target transported by the transport apparatus.

According to this configuration, the same effects as those of the stated transport apparatus can be achieved.

Note that the detection unit and the output unit may be included in the configuration of the recording apparatus, independent from the transport apparatus.

According to another aspect of the invention, it is preferable for the stated recording apparatus to include a display unit that displays a message indicating the result of the comparison before the recording process is carried out.

According to this configuration, the recording process for the transport target can be suppressed from being carried out in a state in which the accuracy of the detection unit is no longer maintained.

### BRIEF DESCRIPTION OF THE DRAWINGS

The invention will be described with reference to the accompanying drawings, wherein like numbers reference like elements.

FIG. 1 is a perspective view of an ink jet printer according to an embodiment.

FIG. 2 is a schematic diagram illustrating internal components of the printer from the side.

FIG. 3 is a cross-sectional schematic diagram illustrating an image capturing unit in the printer.

FIG. 4 is a block diagram illustrating the electrical configuration of the printer.

FIG. 5 is a flowchart illustrating a pre-printing start operation processing routine executed by a control unit of the printer.

### DESCRIPTION OF EXEMPLARY EMBODIMENTS

Hereinafter, an ink jet printer serving as a specific embodiment of a recording apparatus will be described with reference to the drawings.

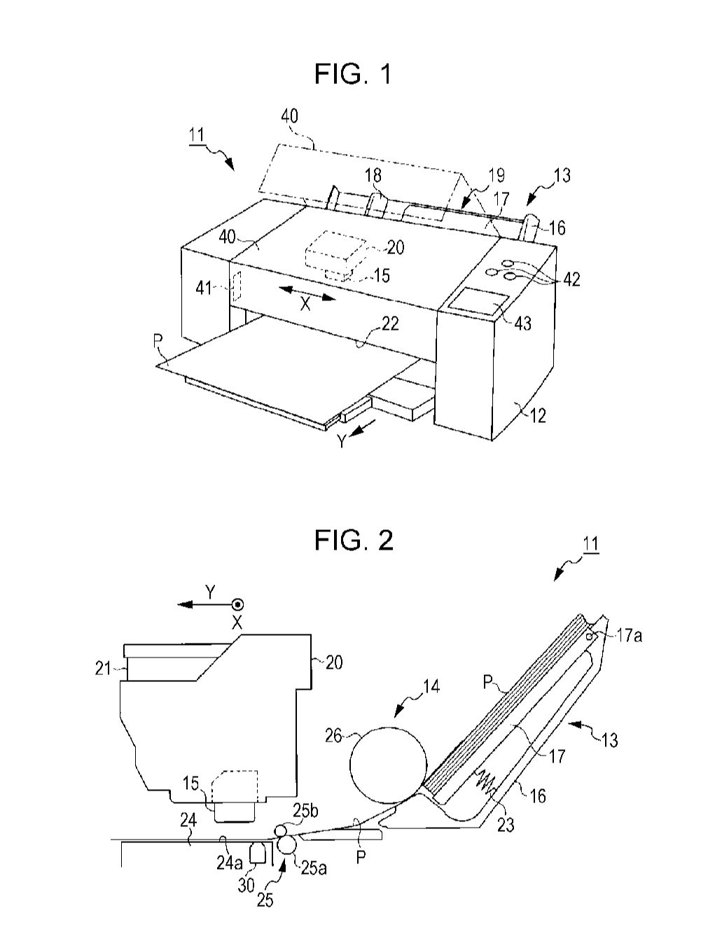

As shown in FIGS. 1 and 2, an ink jet printer 11 serving as an example of the recording apparatus includes an approximately rectangular parallelpiped main body case 12. The main body case 12 includes a paper feed apparatus 13 that feeds paper P (single sheets of paper) serving as an example of a transport target, a transport apparatus 14 that transports each sheet of the paper P fed by the paper feed apparatus 13 along a transport path, and a recording head 15 serving as an example of a recording unit that executes printing (a recording process) by ejecting ink (a liquid) onto the paper P transported by the transport apparatus 14.

The paper feed apparatus 13 is disposed in a rear surface area (the back, in FIG. 1) of the main body case 12, and includes a paper guide 19 having a paper feed tray 16, a hopper 17, and an edge guide 18, and a paper feed driving mechanism (not shown) that feeds a plurality of sheets of the paper P, which has been placed on the paper guide 19 in a stacked state, to the interior of the main body case 12, one sheet at a time.

A carriage 20 that moves back and forth in a main scanning direction X (the horizontal direction, in FIG. 1) using a carriage motor 51 (described later; see FIG. 4) as a driving source is provided within the main body case 12. An ink cartridge 21 is mounted in the carriage 20, and the recording head 15 is supported in a lower area of the carriage 20. Ink held in the ink cartridge 21 is supplied to the recording head 15 via an ink flow channel (not shown).

Printing onto the paper P is executed by alternately repeating a recording operation of ejecting ink from the recording head 15 onto the paper P as the carriage 20 is moved in the main scanning direction X, and a transport operation of transporting the paper P by a predetermined transport amount in a paper P transport direction Y that is orthogonal to the main scanning direction X. Note that the paper P that has been printed onto is discharged from a paper discharge port 22 provided in a lower area of the front surface (the lower front, in FIG. 1) of the main body case 12.

The paper feed tray 16 of the paper feed apparatus 13, disposed at an angle in the rear surface area of the main body case 12, is supported on a lower end side by the main body case 12. The hopper 17 is provided on an upper surface side of the paper feed tray 16. Meanwhile, a compression spring 23 is interposed between a lower end portion of the hopper 17 and the paper feed tray 16.

The hopper 17 is configured so as to be rotatable, central to a shaft 17a provided on an upper end portion thereof, between a paper feed position shown in FIG. 2 and a retracted position in which the hopper 17 is rotated counter-clockwise so that the compression spring 23 is compressed and the lower end side of the hopper 17 moves closer to the paper feed tray 16 than in the state shown in FIG. 2.

A hollow support member 24 that supports the transported paper P is disposed in the main body case 12, below the recording head 15 that is supported in the lower area of the carriage 20. A surface of the support member 24 that opposes the recording head 15 serves as a support surface 24a that supports the paper P being printed onto. A transport roller pair 25 that pinches the paper P and transports the paper P downstream is disposed upstream (to the right, in FIG. 2) from the support member 24 in the transport path of the paper P.

As shown in FIG. 2, the transport roller pair 25 is configured of a transport driving roller 25a that is rotationally driven by a transport motor 53 (mentioned later; see FIG. 4) and a transport slave roller 25b that undergoes slave rotation in response to the rotational driving of the transport driving roller 25a. In addition, a cylindrical paper feed roller 26, for sequentially feeding the plurality of sheets of paper P stacked in the paper guide 19 downstream in the transport path, is disposed in a position upstream (to the right, in FIG. 2) from the transport roller pair 25 in the transport path of the paper P and near the bottom end of the hopper 17, and is capable of being rotationally driven by a paper feed motor 52 (mentioned later; see FIG. 4).

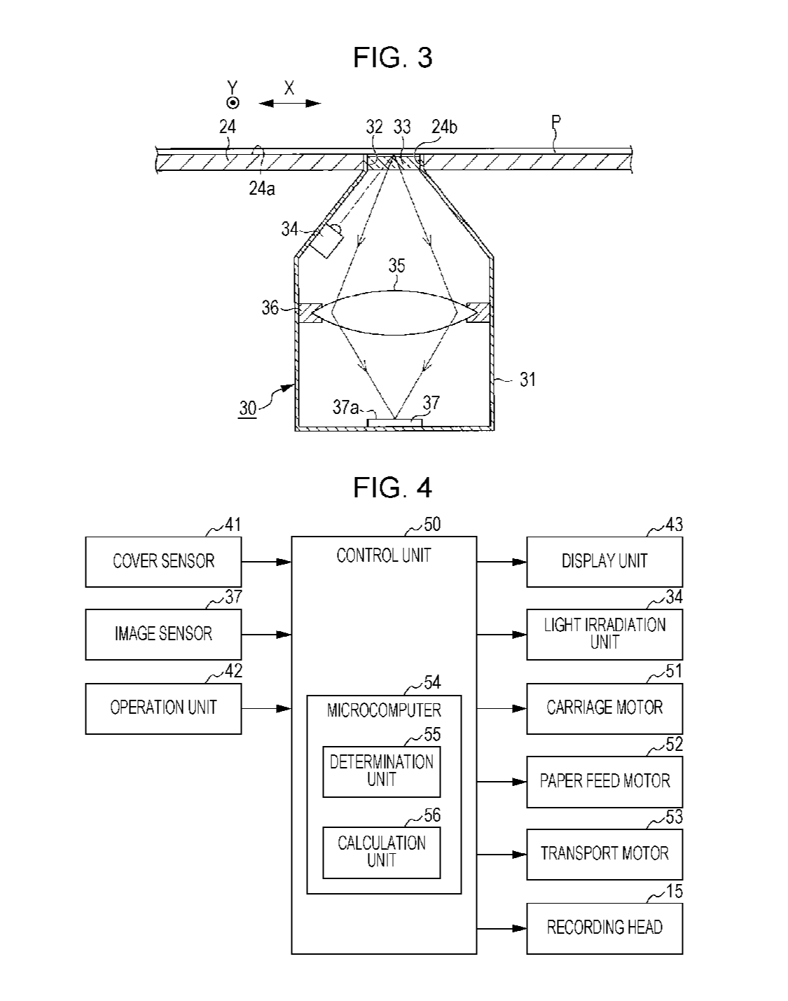

As shown in FIGS. 2 and 3, a through-hole 24b that connects the inside and the outside of the support member 24 is formed in the support surface 24a. An image capturing unit 30, serving as an example of an optical detection unit for obtaining information regarding the position of the paper P without making contact therewith, is affixed to the support member 24, with an upper end portion of the image capturing unit 30 being inserted into the through-hole 24b. In this case, the image capturing unit 30 is disposed within the support member 24.

Next, the configuration of the image capturing unit 30 will be described in detail.

As shown in FIG. 3, the image capturing unit 30 includes a closed-ended quadrangular cylindrical case 31. An upper portion of the case 31 is tapered so that the width thereof narrows toward the upper end. The case 31 is anchored using an anchoring portion (not shown) with the upper end portion thereof being inserted, from the inside of the support member 24, into the through-hole 24b formed in the support member 24. In this case, the upper end of the case 31 is flush with the support surface 24a of the support member 24.

A rectangular opening at the upper end of the case 31 serves as a detection window 32 that is exposed on the support surface 24a, and a colorless, transparent light-transmissive glass 33 that allows light to pass therethrough is embedded in the detection window 32. An upper surface of the light-transmissive glass 33 is disposed in a slightly lower position than the support surface 24a. In other words, the light-transmissive glass 33 is disposed so as to vertically oppose the paper P transported upon the support surface 24a, with a small gap provided between the light-transmissive glass 33 and the paper P.

Accordingly, the light-transmissive glass 33 does not make contact with the paper P. In addition, a light irradiation unit 34 is attached to one side in the main scanning direction X (the left side, in FIG. 3) of an inner circumferential surface of the upper end area of the case 31. The light irradiation unit 34 is configured of a light-emitting diode (LED) in this embodiment, and irradiates the paper P transported upon the support surface 24a through the light-transmissive glass 33 from a lower surface side of the paper P, on the opposite side thereof as a printing surface (that is, a non-printing surface side). In this case, the light irradiation unit 34 is disposed so that light from the main scanning direction X side irradiates the bottom surface (the non-printing surface) of the paper P at an angle.

A focusing lens 35, serving as an example of an optical member, is provided in a position within the case 31 that is further from the paper P than the light irradiation unit 34, or in other words, a position that is lower than the light irradiation unit 34 within the case 31. The focusing lens 35 is held on the inner circumferential surface of the case 31 via a holding member 36, and focuses reflected light, namely light that is emitted from the light irradiation unit 34, passes through the light-transmissive glass 33, is reflected by the bottom surface of the paper P, and enters into the case 31 having passed through the light-transmissive glass 33 once again.

Furthermore, an image sensor 37, serving as an example of an image capturing unit (a light-receiving unit), is provided in a position within the case 31 that is further from the paper P than the focusing lens 35, or in other words, on an inner bottom surface of the case 31. The image sensor 37 has an image capturing surface 37a on which is formed an image of the bottom surface of the paper P that has been focused by the focusing lens 35, and is configured of, for example, a two-dimensional image sensor.

Meanwhile, the focusing lens 35 is held on the inner circumferential surface of the case 31 by the holding member 36 at a height at which an image of the bottom surface of the paper P can be formed on the image capturing surface 37a of the image sensor 37. In this case, the focusing lens 35 is disposed so that the optical axis thereof passes through a center of the detection window 32 and a center of the image capturing surface 37a.

In other words, the image capturing unit 30 is a unit that captures an image of a texture of the bottom surface of the paper P supported by the support surface 24a (that is, a pattern of the paper surface) based on reflected light produced when the paper P is irradiated with light from the light irradiation unit 34, and outputs texture images corresponding to the locations of the paper P that are captured during a set interval of time. A transport amount of the paper P per unit of time is calculated by comparing at least two sequential texture images captured by the image sensor 37 during the set interval of time. Note that in this embodiment, the texture image based on the transport position of the paper P, captured by the image capturing unit 30, corresponds to information regarding the position of the paper P.

Meanwhile, as shown in FIG. 1, a cover member 40 that is formed as an L-shaped plate and can be opened and closed freely is provided on a top surface of the main body case 12. A state in which the cover member 40 is open (that is, a state in which the cover member 40 is in an open position indicated by a dot-dot-dash line in FIG. 1) corresponds to a state in which the carriage 20, the support member 24, and so on within the main body case 12 are exposed. On the other hand, a state in which the cover member 40 is closed (that is, a state in which the cover member 40 is in a closed position indicated by a solid line in FIG. 1) corresponds to a state in which the carriage 20, the support member 24, and so on within the main body case 12 are hidden under the cover member 40.

Accordingly, because the detection window 32 is exposed in the support surface 24a of the support member 24, it can be said that the image capturing unit 30 is disposed in a position that is not affected by ambient light (surrounding light that illuminates the ink jet printer 11) in the case where the cover member 40 is closed but is affected by the ambient light in the case with the cover member 40 is open.

Meanwhile, as shown in FIG. 1, a cover sensor 41 that detects whether the cover member 40 is open or closed is provided in the main body case 12. Furthermore, an operation unit 42 through which a user performs various types of operations of the ink jet printer 11 and a display unit 43 serving as an example of an output unit that outputs messages and the like for catching the user's attention are provided in the top surface of the main body case 12, at one end in the main scanning direction X thereof (the right end, in FIG. 1). The display unit 43 is configured of, for example, a liquid-crystal monitor.

Note that in this embodiment, a transport unit that transports the paper P is configured of the transport roller pair 25 and the paper feed roller 26.

Next, the electrical configuration of the ink jet printer 11 will be described.

As shown in FIG. 4, the ink jet printer 11 includes a control unit 50 that controls the ink jet printer 11 as a whole. The cover sensor 41, the image sensor 37, and the operation unit 42 are each electrically connected to an input-side interface of the control unit 50. The control unit 50 receives electrical signals transmitted from each of the cover sensor 41, the image sensor 37, and the operation unit 42.

Meanwhile, the display unit 43, the light irradiation unit 34, the carriage motor 51, the paper feed motor 52, the transport motor 53, and the recording head 15 are each electrically connected to an output-side interface of the control unit 50. The control unit 50 controls each of the display unit 43, the light irradiation unit 34, and the recording head 15, and controls the driving of each of the carriage motor 51, the paper feed motor 52, and the transport motor 53 via a motor driver (not shown).

The control unit 50 includes a microcomputer 54. The microcomputer 54 includes a CPU, a ROM, and a RAM. Various types of control programs for controlling the ink jet printer 11, various types of information (a set value N set in advance and a postulated value M, which will be described later, as well as a pre-set message for bringing the user's attention to the cover member 40 (in this embodiment, a message reading “The cover member is open. Please close the cover member.”), and so on are stored in the ROM.

Various types of information that can be overwritten as appropriate while the ink jet printer 11 is running are recorded in the RAM. Meanwhile, the microcomputer 54 functions as a determination unit 55 and a calculation unit 56 as a result of the CPU executing programs stored in the ROM. The determination unit 55 compares the brightness of an image captured by the image sensor 37 with the set value N stored in the ROM, and determines whether or not the image is at an appropriate brightness.

The calculation unit 56 calculates the transport amount of the paper P per unit of time by comparing at least two sequential texture images captured by the image sensor (the image capturing unit 30) during the set interval of time.

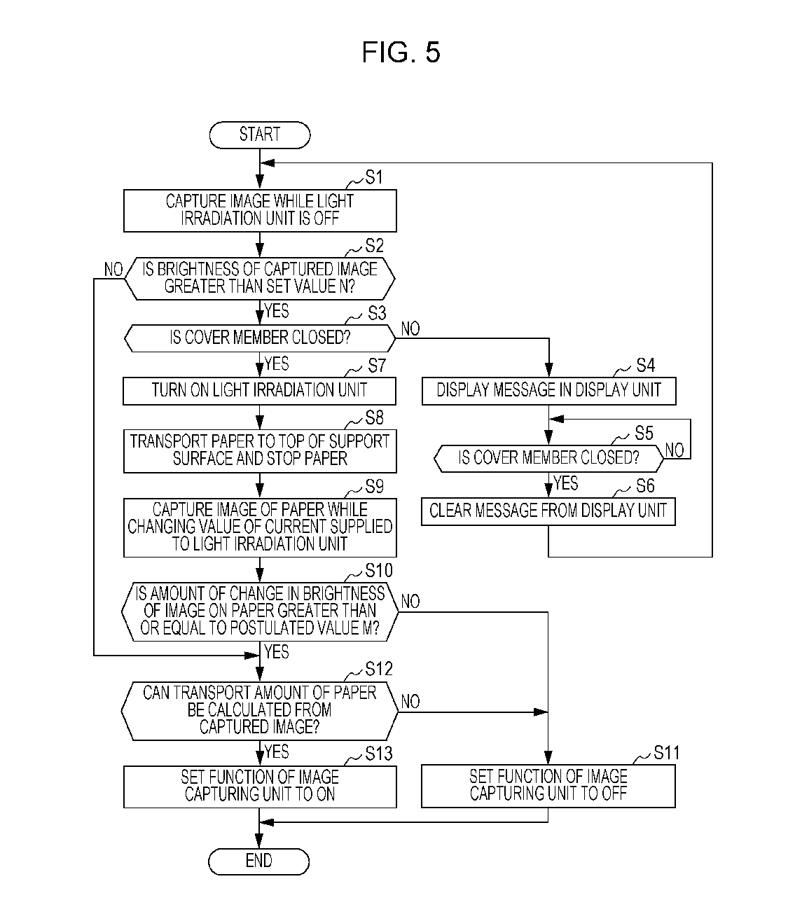

Next, of control processing routines executed by the control unit 50 (specifically, the microcomputer 54) according to this embodiment, a pre-printing start operation processing routine that is executed when the ink jet printer 11 is turned on with the paper P set in the paper feed apparatus 13 (that is, prior to printing) will be described based on the flowchart of FIG. 5.

When the user turns on the ink jet printer 11 by operating the operation unit 42 with the paper P set in the paper feed apparatus 13, the control unit 50 turns off the light irradiation unit 34 (a state where light is not being emitted) and causes the image sensor 37 to capture an image in a state where the paper P is not present on the support surface 24a (step S1). The control unit 50 then determines whether or not the brightness of the image captured in step S1 is greater than the set value N, using the determination unit 55 (step S2).

The set value N is set to an upper limit value at which the image sensor 37 can maintain accuracy when capturing an image of the paper P, even under the influence of ambient light. Accordingly, in the case where the brightness of the image captured in step S1 is greater than the set value N, the accuracy when capturing the image of the paper P using the image sensor 37 cannot be maintained due to the influence of ambient light. On the other hand, in the case where the brightness of the image captured in step S1 is less than or equal to the set value N, the accuracy when capturing the image of the paper P using the image sensor 37 can be maintained even under the influence of ambient light.

In the case where the result of the determination performed in step S2 indicates “no”, the control unit 50 advances the processing to step S12, which will be mentioned later. On the other hand, in the case where the result of the determination performed in step S2 indicates “yes”, the control unit 50 determines whether or not the cover member 40 is closed based on a signal from the cover sensor 41 (step S3). In the case where the result of the determination performed in step S3 indicates “no”, the control unit 50 causes the message reading “The cover member is open. Please close the cover member.” to be displayed in the display unit 43 (step S4).

Next, the control unit 50 determines whether or not the cover member 40 is closed based on a signal from the cover sensor 41 (step S5). In the case where the result of the determination performed in step S5 indicates “no”, the control unit 50 repeats the processing of step S5 until the result of the determination performed in step S5 indicates “yes”. When the result of the determination performed in step S5 indicates “yes”, the control unit 50 clears the message displayed in the display unit 43 in step S4 (step S6), and then returns the process to step S1.

Meanwhile, in the case where the result of the determination performed in step S3 indicates “yes”, the control unit 50 turns on the light irradiation unit 34 (a state where light is being emitted) (step S7). Then, the control unit 50 controls the driving of the paper feed motor 52 and the transport motor 53 so that the paper P is transported to the support surface 24a and stopped (step S8). Next, the control unit 50 causes the image sensor 37 to capture images of the paper P on the support surface 24a while changing the value of a current supplied to the light irradiation unit 34 (step S9).

Next, the control unit 50 determines whether or not a change amount in the brightness of the images of the paper P captured while changing the value of the current supplied to light irradiation unit 34 in step S9 is greater than or equal to a postulated value M (step S10). The postulated value M is set to a lower limit value at which the image sensor 37 can maintain accuracy when capturing an image of the paper P, even under the influence of ambient light.

Accordingly, in the case where the change amount in the brightness of the images captured in step S9 is less than the postulated value M, the accuracy when capturing the image of the paper P using the image sensor 37 cannot be maintained due to the influence of ambient light. On the other hand, in the case where the change amount in the brightness of the images captured in step S9 is greater than or equal to the postulated value M, the accuracy when capturing the image of the paper P using the image sensor 37 can be maintained even under the influence of ambient light.

In the case where the result of the determination performed in step S10 indicates “no”, the control unit 50 sets the function of the image capturing unit 30 to off (that is, stops the function) (step S11), after which the pre-printing start operation processing routine ends. On the other hand, in the case where the result of the determination performed in step S10 indicates “yes”, the control unit 50 determines whether or not the transport amount of the paper P can be calculated from the images that have been captured of the paper P (step S12).

In other words, in step S12, the control unit 50 compares at least two sequential texture images captured by the image sensor 37 during the set interval of time while moving the paper P, and determines whether or not the two images are different. In the case where the two images are different, the transport amount of the paper P can be calculated by comparing the two images; however, in the case where the two images are not different, the transport amount of the paper P cannot be calculated by comparing the two images. For example, the transport amount of the paper P cannot be calculated in the case where the paper P is glossy paper whose surface has been given a highly-reflective coating.

Note that in addition to comparing two sequential texture images from a certain time, the transport amount of the paper P may be calculated by analyzing a trend in a movement direction or the like based on a plurality of texture images captured during a set interval of time.

In the case where the result of the determination performed in step S12 indicates “no”, the control unit 50 sets the function of the image capturing unit 30 to off (that is, stops the function of the image capturing unit 30) (step S11), after which the pre-printing start operation processing routine ends. On the other hand, in the case where the result of the determination performed in step S12 indicates “yes”, the control unit 50 sets the function of the image capturing unit 30 to on (that is, enables the image capturing unit 30 to function) (step S13), after which the pre-printing start operation processing routine ends.

Next, operations of the ink jet printer 11 configured as mentioned above will be described.

In the case where the paper P is to be printed onto, first, the user turns on the ink jet printer 11 by operating the operation unit 42. If the cover member 40 is open at this time, the message reading “The cover member is open. Please close the cover member.” is displayed in the display unit 43. When the user views this message and closes the cover member 40, the operation for printing onto the paper P is started.

When the printing operation is started, the paper P in the paper feed apparatus 13 is transported from the upstream side toward the downstream side along the transport path of the paper P. Printing is carried out by ejecting ink onto the transported paper P from the recording head 15 when the paper P is on the support surface 24a. At this time, the image capturing unit 30 captures an image of the texture of the bottom surface of the paper P supported by the support surface 24a (that is, a pattern of the paper surface) based on reflected light produced when the paper P is irradiated with light from the light irradiation unit 34. Then, the transport amount of the paper P per unit of time is calculated by comparing at least two sequential images of the bottom surface of the paper P captured by the image capturing unit 30 during the set interval of time.

Incidentally, if the paper P is printed onto while the cover member 40 is open, the image capturing unit 30 will be affected by ambient light, and the accuracy of the captured images of the texture on the bottom surface of the paper P will no longer be maintained. Accordingly, there is a problem that the accuracy of the calculation of the transport amount of the paper P per unit of time will drop.

With respect to this point, in this embodiment, in the case where the cover member 40 is open while the ink jet printer 11 is on, a message prompting the user to close the cover member 40 is displayed in the display unit 43. Accordingly, the printing is suppressed from being executed while the cover member 40 is open. Accordingly, the paper P is suppressed from being printed onto in a state where the accuracy of the image capturing performed by the image capturing unit 30 is no longer maintained.

According to the embodiment described in detail thus far, the following effects can be achieved.

1. With the ink jet printer 11, in the case where the brightness of the image captured by the image sensor 37 is greater than the set value N, a message for bringing the user's attention to the cover member 40 (“The cover member is open. Please close the cover member.”) is displayed in the display unit 43. Accordingly, the user can be prompted to close the cover member 40, and thus it is possible to suppress the ink jet printer 11 from being used in a state in which the accuracy is no longer maintained because the cover member 40 is open and the image capturing unit 30 is affected by ambient light due to the cover member 40 being open.

2. With the ink jet printer 11, in the case where the determination unit 55 determines that the brightness of the image captured by the image sensor 37 is greater than the set value N while the light irradiation unit 34 is not emitting light, the message for bringing the user's attention to the cover member 40 (“The cover member is open. Please close the cover member.”) is displayed in the display unit 43. Accordingly, in the case where the determination unit 55 determines whether or not the brightness of the image captured by the image sensor 37 is greater than the set value N due to the influence of ambient light, the accuracy of the determination performed by the determination unit 55 can be suppressed from dropping due to the light from the light irradiation unit 34.

3. With the ink jet printer 11, in the case where the brightness of the image captured by the image sensor 37 is greater than the set value N prior to the paper P being printed onto, a message for bringing the user's attention to the cover member 40 (“The cover member is open. Please close the cover member.”) is displayed in the display unit 43. Accordingly, the user can be prompted to close the cover member 40 prior to printing onto the paper P, and thus it is possible to suppress the ink jet printer 11 from starting to print onto the paper P in a state in which the accuracy is no longer maintained because the cover member 40 is open and the image capturing unit 30 is affected by ambient light due to the cover member 40 being open.

Variations

Note that the aforementioned embodiment may be modified as described hereinafter.

The set value N may be a range of suitable values, and in the case where the brightness of the image is greater than the range of suitable values, it may be determined that the image sensor 37 has not been influenced by ambient light but has instead malfunctioned by comparing the open state and closed state of the cover member 40. Meanwhile, in the case where the brightness of the image is less than the range of suitable values, it may be determined that the image sensor 37 has malfunctioned; likewise, if the light irradiation unit 34 is supposed to be emitting light at that time, it may be determined that the light irradiation unit 34 has malfunctioned. Furthermore, the message may be displayed even in the case where the brightness of the image is less than the range of suitable values.

With the ink jet printer 11, in the case where the brightness of the image captured by the image sensor 37 is greater than the set value N during printing onto the paper P, a message for bringing the user's attention to the cover member 40 (“The cover member is open. Please close the cover member.”) may be displayed in the display unit 43.

With the ink jet printer 11, in the case where the determination unit 55 determines that the brightness of the image captured by the image sensor 37 is greater than the set value N while the light irradiation unit 34 is emitting light, the message for bringing the user's attention to the cover member 40 (“The cover member is open. Please close the cover member.”) may be displayed in the display unit 43.

In the pre-printing start operation processing routine, step S3 and steps S7 to S10 may be omitted, and in the case where the result of the determination performed in step S2 indicates “yes”, the process may advance to step S4.

In the pre-printing start operation processing routine, step S3 may be omitted, and in the case where the result of the determination performed in step S2 indicates “yes”, the process may advance to step S4; step S6 may include a process of setting a flag indicating that the result of the determination performed in step S5 was “yes” to on. Then, a process for advancing to step S7 in the case where the flag is on may be added between step S2 and step S4.

In the pre-printing start operation processing routine, the same determination process as that in step S2 may be added between step S3 and step S7, and in the case where the result of the determination performed in that determination process indicates “yes”, a message for bringing the user's attention to exterior light, such as “Do not shine bright light on the printer.”, may be displayed in the display unit 43.

The determination unit 55 may be configured of a comparator that compares a voltage value corresponding to the brightness of the image captured by the image sensor 37 with a voltage value corresponding to the set value N.

The message displayed in the display unit 43 may be changed to “Please close the cover member.”, “The cover member is open.”, or the like, for example, rather than “The cover member is open. Please close the cover member.”

The output unit may output the aforementioned message as audio rather than displaying the message in the display unit 43. Likewise, the message may be communicated by lighting or extinguishing a lamp or the like.

The determination unit 55 may perform the determination based on a received light amount rather than the brightness of the captured image, and the detection unit may be configured having a light-receiving unit that receives light such as reflected light or transmitted light, rather than having the image capturing unit.

The transport target may be cloth, a plastic film, a metal foil, or the like, as long as there is a texture on the surface thereof.

The ink jet printer 11 may be a line printer.

In the above embodiment, the recording apparatus may be a fluid ejecting apparatus that records by ejecting or discharging a fluid aside from ink (including liquids, liquid bodies in which the particles of a functional material are dispersed throughout or mixed with a liquid, and fluids such as gels (including solids that flow and can be ejected like liquids)). For example, the recording apparatus may be a fluid ejecting apparatus that records by ejecting fluids including materials such as electrode materials, coloring materials (pixel materials), and so on in a dispersed or dissolved state for use in the manufacture and so on of, for example, liquid-crystal displays, EL (electroluminescence) displays, front emission displays, and so on. Alternatively, the recording apparatus may be a fluid ejecting apparatus that ejects a fluid such as a gel (for example, a physical gel), a powder ejecting apparatus (for example, a toner jet-type recording apparatus) that ejects a solid such as a toner powder, or the like. The invention can be applied to any type of these fluid ejecting apparatuses. Note that in this specification, “fluid” refers to a concept that does not include fluids composed only of gases; rather, “fluid” refers to liquids (inorganic agents, organic agents, solutions, liquid resins, liquid metals (metallic melts), and so on), liquid bodies, fluid bodies, powders (in powder form, particulate form, and so on), and the like.

The transport apparatus is not limited to a transport apparatus provided in a recording apparatus that performs a recording process on a transport target, and may be provided in various types of processing apparatuses that perform desired processes on a transport target.

The entire disclosure of Japanese Patent Application No.2012-255010, filed Nov. 21, 2012 is expressly incorporated by reference herein.

What is claimed is:

1. A transport apparatus comprising:
a transport unit that transports a transport target;
an optical detection unit, including a light irradiation unit capable of irradiating the transport target with light and a light-receiving unit that receives light, that detects the transport target; and
an output unit that compares a light receiving result from the light-receiving unit with a set value that has been set in advance and outputs a result of the comparison.

2. The transport apparatus according to claim 1,
wherein the light-receiving unit is an image capturing unit that captures an image by receiving light, and the light receiving result is a brightness of an image captured by the image capturing unit.

3. The transport apparatus according to claim 1,
wherein the output unit outputs the result of the comparison in a state where the light irradiation unit is not emitting light.

4. The transport apparatus according to claim 1, further comprising:
a cover member that can be freely opened and closed,
wherein the detection unit is disposed in a position where the detection unit is not affected by ambient light while the cover member is closed but is affected by the ambient light while the cover member is open.

5. A recording apparatus comprising:
the transport apparatus according to claim 1; and
a recording unit that performs a recording process on the transport target transported by the transport apparatus.

6. A recording apparatus comprising:
the transport apparatus according to claim 2; and
a recording unit that performs a recording process on the transport target transported by the transport apparatus.

7. A recording apparatus comprising:
the transport apparatus according to claim 3; and
a recording unit that performs a recording process on the transport target transported by the transport apparatus.

8. A recording apparatus comprising:
the transport apparatus according to claim 4; and
a recording unit that performs a recording process on the transport target transported by the transport apparatus.

9. The recording apparatus according to claim 5, further comprising:
a display unit that displays a message indicating the result of the comparison before the recording process is carried out.

10. The recording apparatus according to claim 6, further comprising:
a display unit that displays a message indicating the result of the comparison before the recording process is carried out.

11. The recording apparatus according to claim 7, further comprising:
a display unit that displays a message indicating the result of the comparison before the recording process is carried out.

12. The recording apparatus according to claim 8, further comprising:
a display unit that displays a message indicating the result of the comparison before the recording process is carried out.
